(19) United States
(12) Patent Application Publication
(10) Pub. No.: US 2002/0118783 A1
(43) Pub. Date: Aug. 29, 2002

(54) Smart antenna based spectrum multiplexing using a pilot signal

(76) Inventors: Peter Cripps, Redwood City, CA (US); Haim Harel, New York, NY (US); Alexander Segalovitz, Kefar Sava (IL)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/082,351

(22) Filed: Feb. 26, 2002

Related U.S. Application Data
(60) Provisional application No. 60/270,895, filed on Feb. 26, 2001.
(60) Provisional application No. 60/286,047, filed on Apr. 25, 2001.

(51) Int. Cl. H04L 1/02

(52) U.S. Cl. 375/347

(57) ABSTRACT

A system and method for using a pilot signal in a communication receiver having multiple antenna elements is described. A set of data signals and a set of pilot signals are received. A first pilot signal from the set of pilot signals is identified based on a first characteristic of the first pilot signal from the set of pilot signals. A set of weight values associated with the antenna elements are adjusted so that a second characteristic of the first pilot signal is substantially optimized with respect to the second characteristic of the remaining pilot signals from the set of pilot signals. Consequently, a first data signal from the set of data signals and being uniquely associated with the first pilot signal is substantially optimized by the adjusting of the set of weight values associated with the antenna elements.

### CROSS-REFERENCE TO RELATED APPLICATIONS

This application claims priority to co-pending U.S. Provisional Patent Application No. 60/270,895, entitled “Smart Antennae: Using Pilot for Identification and Quality Measurements,” filed on Feb. 26, 2001; and co-pending U.S. Provisional Patent Application No. 60/286,047, entitled “Smart Antennae: Using OFDM Pilots for Identification and Quality Measurement,” filed on Apr. 25, 2001. The entirety of both applications is incorporated herein by reference.

### BACKGROUND

The present invention relates generally to communications and more particularly to a system and method for using a pilot signal added to a transmitted signal in a communication system, and used by the receiving end, in conjunction with multiple antenna elements. The receiver can implement a separation process known as spatial filtering, or also referred to herein as smart antenna.

Broadband networks having multiple information channels are subject to certain types of typical problems such as inter-channel interference and a limited bandwidth per information channel. For example, broadband wireless networks can use cellular and frequency-reuse schemes to extend service areas for a given range of allocated frequencies. In such a broadband wireless network, a large number of different frequency bands are used for the overall system. Adjacent cells are then able to use a different frequency band to minimize interference.

This large number of frequency bands, however, involves an extensive spectrum allocation that can be expensive or difficult. In addition, a limited amount of bandwidth is available for each frequency associated with a given cell.

In sum, a need exists for an improved system and method that can significantly reduce the amount allocated spectrum to communicate a given amount of data or that can significantly increase the amount of data for a given amount of allocated spectrum.

### SUMMARY OF THE INVENTION

A system and method for using a pilot signal in a communication receiver having multiple antenna elements is described. A set of data signals and a set of pilot signals are received. A first pilot signal from the set of pilot signals is identified based on a first characteristic of the first pilot signal from the set of pilot signals. A set of weight values associated with the antenna elements are adjusted so that a second characteristic of the first pilot signal is substantially optimized with respect to the second characteristic of the remaining pilot signals from the set of pilot signals. Consequently, a first data signal from the set of data signals and being uniquely associated with the first pilot signal is substantially optimized by the adjusting of the set of weight values associated with the antenna elements.

### BRIEF DESCRIPTION OF THE DRAWINGS

FIG. 1 shows a system block diagram of a communication system using downlink spectrum multiplexing, according to an embodiment of the invention.

FIG. 2 shows a system block diagram of a communication system using uplink spectrum multiplexing, according to an embodiment of the invention.

FIG. 3 shows a graph of frequency versus amplitude for data signals and pilot signals within an allocated frequency band according to an embodiment of the invention.

FIGS. 4A through 4D show a system block diagram of a transmitter having a pilot transmit subsystem, according to an embodiment of the invention.

FIG. 5 shows a system block diagram of a receiver having a pilot receive subsystem, according to an embodiment of the invention.

FIG. 6 shows a flowchart for receiving and enhancing data signals according to an embodiment of the present invention.

FIG. 7 shows a system block diagram of a pilot-receive subsystem according to an embodiment of the invention.

FIG. 8 shows a flowchart for separating and maximizing the desired pilot signal according to an embodiment of the present invention.

### DETAILED DESCRIPTION

The disclosed system and method uses a pilot signal to identify and enhance a desired data signal while minimizing undesired data signals. A desired communication source (e.g., a desired basestation) transmits a data signal and a pilot signal. A communication receiver receives the data signal and the pilot signal from the desired communication source and at the same time receives data signals and the pilot signals from undesired communication sources (e.g., undesired basestations). Thus, from the perspective of the communication receiver, it receives data signals and pilot signals where each data signal is uniquely associated with a pilot signal. The communication receiver then identifies the pilot signal from the desired communication source based on a first characteristic of the pilot signal. For example, the first characteristic of the pilot signal can be a unique frequency. The communication receiver, having multiple antenna elements, calculates weight values for each antenna element so that a second characteristic of the desired pilot signal is substantially optimized with respect to the second characteristic of the remaining undesired received pilot signals. The second characteristic of the pilot signals can be, for example, a power level. Accordingly, once the communication receiver has been optimized to receive the desired pilot signal, receiving the desired data signal will also be optimized.

The transmission of the pilot signal can be performed on the uplink and/or the downlink. For example, in a wireless communication system having multiple basestations and multiple handsets, a pilot signal can be transmitted on the downlink from each basestation. In this configuration, a handset receiving signals from multiple basestations can use the pilot signal from the desired basestation to optimize the data signal from that desired basestation. In such a configuration, each handset includes multiple antenna elements. In an alternative configuration, a pilot signal can be transmitted on the uplink from each handset. In this configuration, a basestation receiving signals from multiple handsets can use the pilot signal from the desired handset to optimize the data signal from that desired handset. In this configuration, each basestation includes multiple antenna elements.

Note that embodiments of the invention can be used in wireless or wired communications. For example, an embodiment of the invention can be used in multiple-channel wireless communications using, for example, the WiFi (i.e., the IEEE 802.11A) standard. For another example, an embodiment of the invention can be used in a multiple-channel cable system using, for example, the Data Over Cable Service Interface Specifications (DOCSIS) standard.

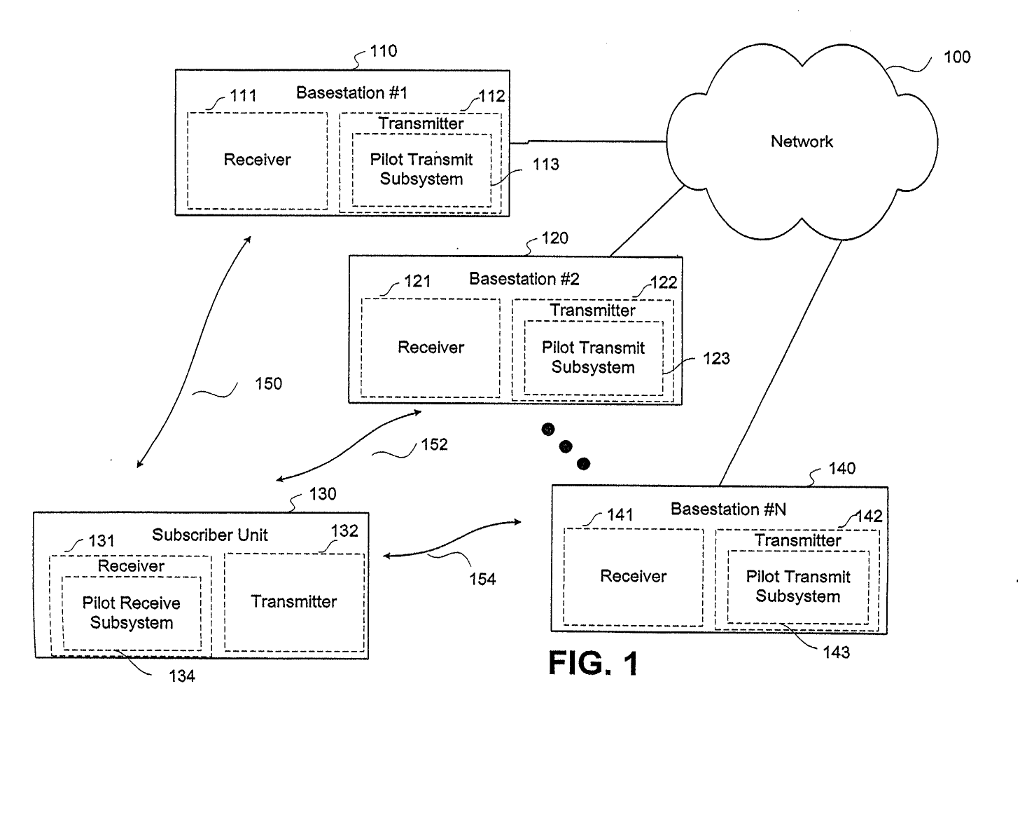

FIG. 1 shows a system block diagram of a communication system using downlink spectrum multiplexing, according to an embodiment of the invention. As shown in FIG. 1, network 100 is coupled to basestations 110, 120 and 140, which can in turn be coupled to subscriber unit 130. Note that although FIG. 1 shows three basestations 110, 120 and 140, any number N of basestations can be coupled to network 100. Basestation 110 includes receiver 111 and transmitter 112, which also includes pilot transmit subsystem 113. Basestation 120 includes receiver 121 and transmitter 122, which also includes pilot transmit subsystem 123. Basestation 140 includes receiver 141 and transmitter 142, which also includes pilot transmit subsystem 143. Basestations 110, 120 and 140 can be coupled to subscriber unit 130, for example, by wireless links 150, 152 and 154, respectively. Subscriber unit 130 includes transmitter 132 and receiver 131, which includes pilot receive subsystem 134. In addition, subscriber unit 130 includes a number M of multiple antenna elements that are uncorrelated. In this embodiment, the number N of basestations 110, 120 and 140 can be, for example, greater than the number M of antenna elements at subscriber unit 130.

For the embodiment shown in FIG. 1, downlink spectrum multiplexing is performed by multiple basestations that are transmitting over the same broadband channel frequency band (also referred to herein as a data-frequency band). Each basestation 110, 120 and 140 also transmits a narrowband pilot signal with the broadband modulated data signal. The narrowband pilot signal sent by each basestation 110, 120 and 140 is slightly different from the remaining pilot signals sent by the remaining basestations 110, 120 and 140. In this embodiment, the pilot signals are slightly different from each other in the sense that each pilot signal has an associated frequency band that differs from the frequency bands for the remaining pilot signals.

The subscriber unit 130 uses multiple antenna elements so that the desired broadband signal can be enhanced and the undesired broadband signals can be suppressed. The desired broadband signal originates from the basestation that targets this subscriber. The undesired broadband signals originate from the basestations that do not target this subscriber although they send data signals within the same channel (the same channel defined, for example, by the same time, frequency or code depending on the system configuration). The subscriber's unit 130 suppresses undesired broadband data signals and enhances the desired broadband data signal by monitoring only the different narrowband pilot signals and manipulating the different antenna elements output so that the desired narrowband pilot signals is enhanced while the undesired narrowband pilot signals are suppressed.

In sum, an embodiment using downlink spectrum multiplexing allows multiple basestations each to transmit a narrowband pilot signal with its broadband data signal. The broadband data signal sent by these multiple basestations can be within the same frequency band. Meanwhile, the subscriber units configured to communicate with one or more of these basestations each have multiple antenna elements and a pilot receive subsystem that uses the received pilot signals to enhance the desired data signal.

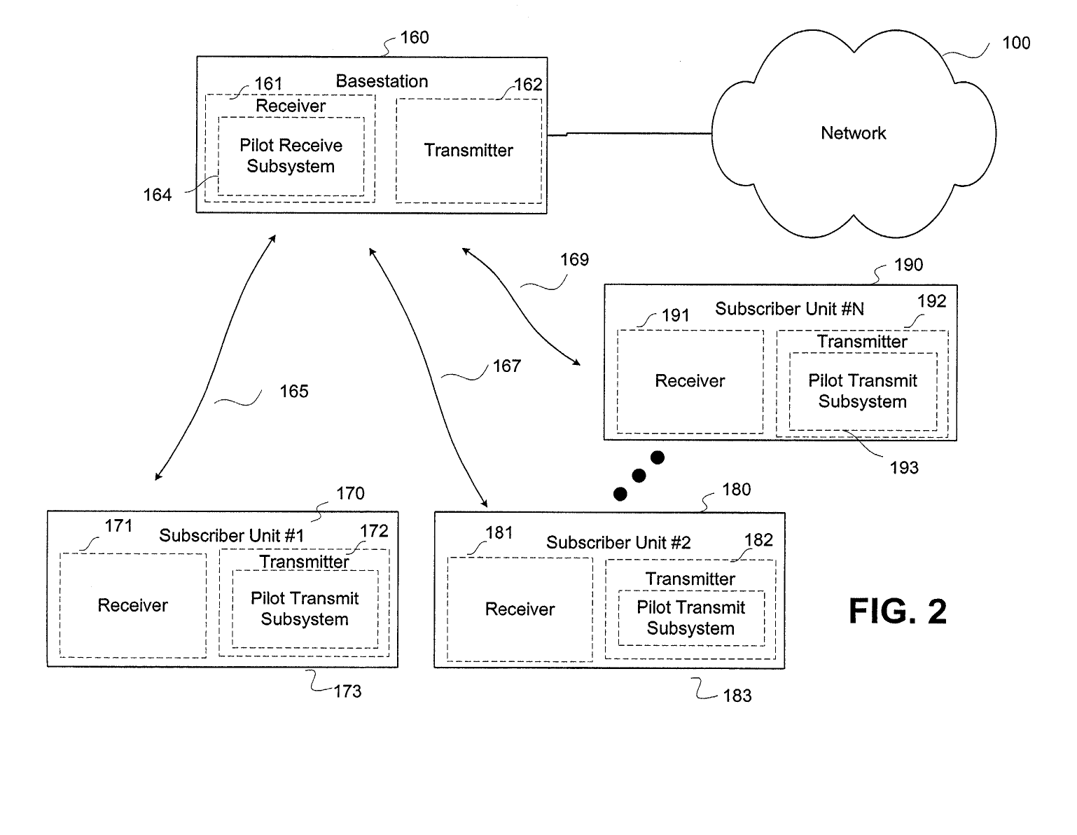

FIG. 2 shows a system block diagram of a communication system using uplink spectrum multiplexing, according to an embodiment of the invention. As shown in FIG. 2, network 100 is coupled to basestation 160, which can in turn be coupled to subscriber units 170, 180 and 190. Note that although FIG. 2 shows three subscriber units 170, 180 and 190, any number N of subscriber units can be coupled to basestation 160. Similarly, other basestations (not shown in FIG. 2) can be coupled to network 100. Subscriber unit 170 includes receiver 171 and transmitter 172, which also includes pilot transmit subsystem 173. Subscriber unit 180 includes receiver 181 and transmitter 182, which also includes pilot transmit subsystem 183. Subscriber unit 190 includes receiver 191 and transmitter 192, which also includes pilot transmit subsystem 193. Subscriber units 170, 180 and 190 can be coupled to basestation 160, for example, by wireless links 165, 167 and 169, respectively. Basestation 160 includes transmitter 162 and receiver 161, which includes pilot receive subsystem 164. In addition, basestation 160 includes a number M of multiple antenna elements that are uncorrelated. In this embodiment, the number N of subscriber units 170, 180 and 190 can be, for example, greater than the number M of antenna elements are basestation 160.

For the embodiment shown in FIG. 2, uplink spectrum multiplexing is performed by multiple subscriber units that are transmitting over the same broadband channel frequency band (also referred to herein as a data-frequency band). Each subscriber units 170, 180 and 190 also transmits a narrowband pilot signal with the broadband modulated data signal. The narrowband pilot signal sent by each subscriber unit 170, 180 and 190 is slightly different from the remaining pilot signals sent by the remaining subscriber units 170, 180 and 190. In this embodiment, the pilot signals are slightly different from each other in the sense that each pilot signal has an associated frequency band that differs from the frequency bands for the remaining pilot signals.

The basestation 160 uses multiple antenna elements so that the desired broadband signal can be enhanced and the undesired broadband signals can be suppressed. The desired broadband signal originates from the subscriber unit that is targeted the basestation 160. The undesired broadband signals originate from the subscriber units that do not target this basestation 160 although they send data signals within the same data-frequency band. The basestation 160 suppresses undesired broadband data signals and enhances the desired broadband data signal by monitoring only the different narrowband pilot signals and manipulating the different antenna elements output so that the desired narrowband pilot signals is enhanced while the undesired narrowband pilot signals are suppressed.

In sum, an embodiment using uplink spectrum multiplexing allows multiple subscriber units each to transmit a narrowband pilot signal with its broadband data signal. The broadband data signal sent by these multiple subscriber units can be within the same frequency band. Meanwhile, the basestation configured to communicate with one or more of these subscriber units has multiple antenna elements and a pilot receive subsystem that uses the received pilot signals to enhance the desired data signal.

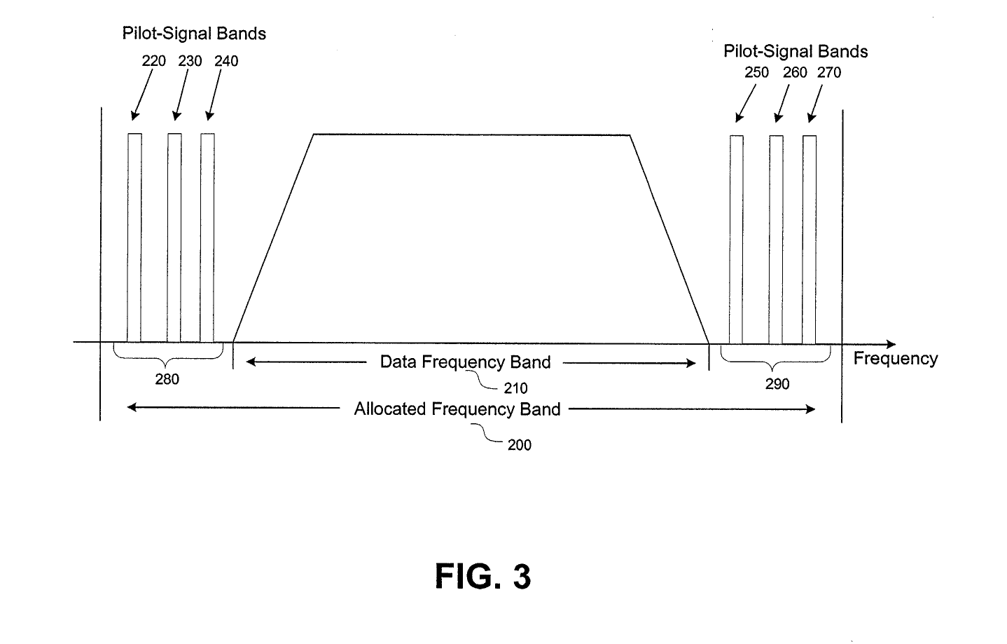

FIG. 3 shows a graph of frequency versus amplitude for data signals and pilot signals within an allocated frequency band according to an embodiment of the invention. As shown in FIG. 3, an allocated frequency band 200 includes a data frequency band 210 and pilot-signal bands 220 through 270. The data frequency band 210 uses a portion, for example, 90 percent of the allocated frequency band 200. The remaining portions 280 and 290 of the allocated frequency band 200 are typically used as guard bands (also referred to as being outside of the power-spectrum mask). These remaining portions 280 and 290 can be, for example, a total of 10 percent of the allocation frequency band 200 (i.e., 5 percent on either side of the data frequency band 210). Within these remaining portions 280 and 290 of the allocated frequency band 200, the pilot signals 220 through 270 can be allocated. In sum, the data frequency band 210 can be a broadband channel frequency band and the pilot-signal bands 220 through 270 can be narrowband frequency band.

More specifically, pilot signals 220 through 240 can be allocated within portion 280 and pilot signals 250 through 270 can be allocated within portion 290. For example, pilot signals 220 through 270 each can represent about one percent of the total allocated frequency within allocation frequency band 200. In such a configuration, each pilot signal 220 through 240 can have a signal-to-noise ratio (SNR) similar to the SNR of the data signals within data frequency band 210 without interfering with the data signals within data frequency band 210 or adjacent pilot signals. For example, where the data-frequency band is 90 percent of the allocated-frequency band and each pilot-signal band is one percent of the allocated-frequency band, a corresponding pilot signal has a (10 log(90/1)−20) dB advantage in SNR.

Thus, following the example of downlink spectrum multiplexing shown in FIG. 1, basestation 110 can send its own data signal within data frequency band 210 and a pilot signal within pilot-signal band 220. Basestation 120 can send its own data signal within data frequency band 210 and a pilot signal within pilot-signal band 230. Basestation 140 can send its own data signal within data frequency band 210 and a pilot signal within pilot-signal band 240. Other basestations not shown in FIG. 1 can send their own data signals within data frequency band 210 and their own pilot signal within pilot-signal bands 250 through 270. Note that the data signals for basestations 110, 120 and 140 and the basestations not shown in FIG. 1 are within and overlap with the data-frequency band 210.

In this configuration, the pilot signals within pilot-signal bands 220 through 270 each have two characteristics that allow for identification and the enhancement of desired data signals. The first characteristic is the frequency of the pilot signal, for example, the center frequency or the specific frequency band. A receiver, such as subscriber unit 130, can know beforehand which basestation is the desired source. The corresponding pilot signal will also then be known. Consequently, a band filter can be used to identify and isolate the desired pilot signal.

The second characteristic of the pilot signals is the power of the pilot signal, for example, the integrated power across the entire pilot-signal band for the desired pilot signal. Again following the example shown in FIG. 1, basestation 110 having a pilot signal within pilot-signal band 220 can be the desired basestation for subscriber unit 130. Consequently, subscriber unit 130 can adjust weight values associated with the antenna elements (not shown in FIG. 1) to maximize the total power of the desired pilot signal within pilot-signal band 220.

Similarly, following the example of uplink spectrum multiplexing shown in FIG. 2, subscriber unit 170 can send its own data signal within data frequency band 210 and a pilot signal within pilot-signal band 220. Subscriber unit 180 can send its own data signal within data frequency band 210 and a pilot signal within pilot-signal band 230. Subscriber unit 190 can send its own data signal within data frequency band 210 and a pilot signal within pilot-signal band 240. Other subscriber units not shown in FIG. 2 can send their own data signals within data frequency band 210 and their own pilot signal within pilot-signal bands 250 through 270. Note that the data signals for subscriber units 170, 180 and 190 and the subscriber units not shown in FIG. 2 are within and overlap with the data-frequency band 210.

In this configuration, the pilot signals within pilot-signal bands 220 through 270 each have two characteristics that allow for identification and the enhancement of desired data signals. The first characteristic is the frequency of the pilot signal, for example, the center frequency or the specific frequency band. A receiver, such as basestation 160, can know beforehand which subscriber unit is the desired source. The corresponding pilot signal will also then be known. Consequently, a band filter can be used to identify and isolate the desired pilot signal.

The second characteristic of the pilot signals is the power of the pilot signal, for example, the integrated power across the entire pilot-signal band for the desired pilot signal. Again following the example shown in FIG. 2, subscriber unit 170 having a pilot signal within pilot-signal band 220 can be the desired subscriber unit for basestation 160. Consequently, basestation 160 can adjust weight values associated with the antenna elements (not shown in FIG. 2) to maximize the total power of the desired pilot signal within pilot-signal band 220.

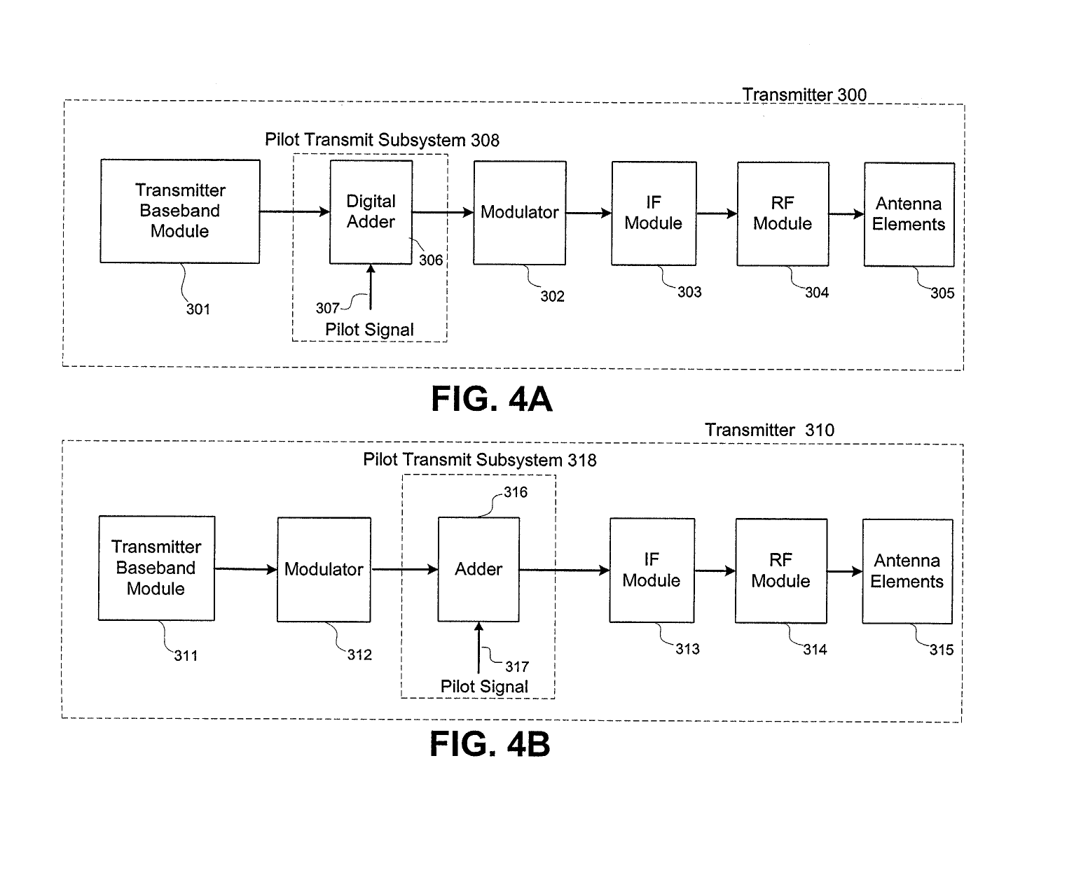

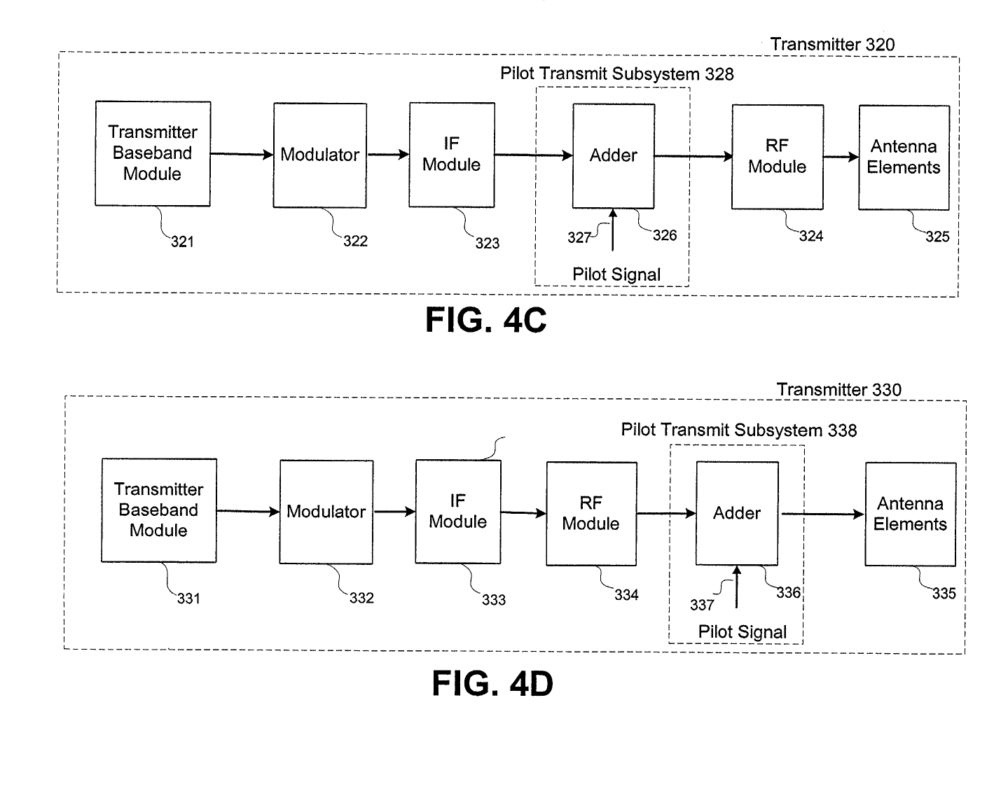

Note that the example shown in FIG. 3 is merely for explanatory purposes. Any other configurations, the specific size of the allocated frequency band 200, the data frequency band 210 and the pilot-signal bands 220 through 270 can be different. In addition, the example shown in FIG. 3 is based on a specific embodiment where the pilot signals are narrow band signals within the guard band. Many other types of embodiments are possible where the pilot signals, for example, are within the data frequency band of a spread spectrum system, created as an artificial multipath, embedded within an orthogonal frequency division multiplexing (OFDM) system, etc. These and other examples of different embodiments are discussed below after the discussion of FIGS. 4 through 8 in connection with the narrow-band pilot-signal example.

FIGS. 4A through 4D shows a system block diagram of a transmitter having a pilot transmit subsystem, according to an embodiment of the invention. By way of illustration, FIGS. 4A through 4D show a system block diagram of transmitters 300, 310, 320 and 330. Any of these transmitters 300, 310, 320 and 330 can correspond to the any of the tranmitters 112, 122 and 142 of FIG. 1 and transmitters 172, 182 and 192 of FIG. 2.

As shown in FIG. 4A, transmitter 300 includes transmitter baseband module 301, pilot transmit subsystem 308, modulator 302, intermediate frequency (IF) module 303, radio frequency (RF) module 304 and antenna elements 305. These components are coupled in series. Pilot transmit subsystem 308 includes digital adder 306, which receives a digital pilot signal 307. The data signal to be transmitted by transmitter 300 is provided from transmitter baseband module 301 to digital adder 306. This data signal is in digital form. The digital adder 306 adds digital pilot signal 307 to the digital data signal. The digital data signal and digital pilot signal are converted to analog signals by modulator 302. The frequencies of these analog signals are converted from baseband frequencies to intermediate frequencies by IF module 303. The frequencies of these signals are then converted to radio frequencies by RF module 304. These signals are then transmitted by antenna elements 305.

As shown in FIG. 4B, transmitter 310 includes transmitter baseband module 311, modulator 312, pilot transmit subsystem 318, IF module 313, RF module 314 and antenna elements 315. These components are coupled in series. Pilot transmit subsystem 318 includes adder 316, which receives an analog pilot signal 317. The data signal to be transmitted by transmitter 310 is provided from transmitter baseband module 311 to modulator 312. The digital data signal is converted to an analog signal by modulator 312. The digital signal is provided to adder 316, which adds the analog pilot signal 317. The frequencies of these analog signals are converted from baseband frequencies to intermediate frequencies by IF module 313. The frequencies of these signals are then converted to radio frequencies by RF module 314. These signals are then transmitted by antenna elements 315.

As shown in FIG. 4C, transmitter 320 includes transmitter baseband module 321, modulator 322, IF module 323, pilot transmit subsystem 328, RF module 324 and antenna elements 325. These components are coupled in series. Pilot transmit subsystem 328 includes adder 326, which receives an analog pilot signal 327. The data signal to be transmitted by transmitter 320 is provided from transmitter baseband module 321 to modulator 322. The digital data signal is converted to an analog signal by modulator 322. The frequencies of this analog data signal are converted from baseband frequencies to intermediate frequencies by IF module 323. The analog data signal is provided to adder 326, which adds the analog pilot signal 327. The frequencies of these signals are then converted to radio frequencies by RF module 324. These signals are then transmitted by antenna elements 325.

As shown in FIG. 4D, transmitter 330 includes transmitter baseband module 331, modulator 332, IF module 333, RF module 334, pilot transmit subsystem 338 and antenna elements 335. These components are coupled in series. Pilot transmit subsystem 338 includes adder 336, which receives an analog pilot signal 337. The data signal to be transmitted by transmitter 330 is provided from transmitter baseband module 331 to modulator 332. The digital data signal is converted to an analog signal by modulator 332. The frequencies of this analog data signal are converted from baseband frequencies to intermediate frequencies by IF module 333. The frequencies of this analog data signal are then converted to radio frequencies by RF module 334. The analog data signal is provided to adder 336, which adds the analog pilot signal 337. These signals are then transmitted by antenna elements 335.

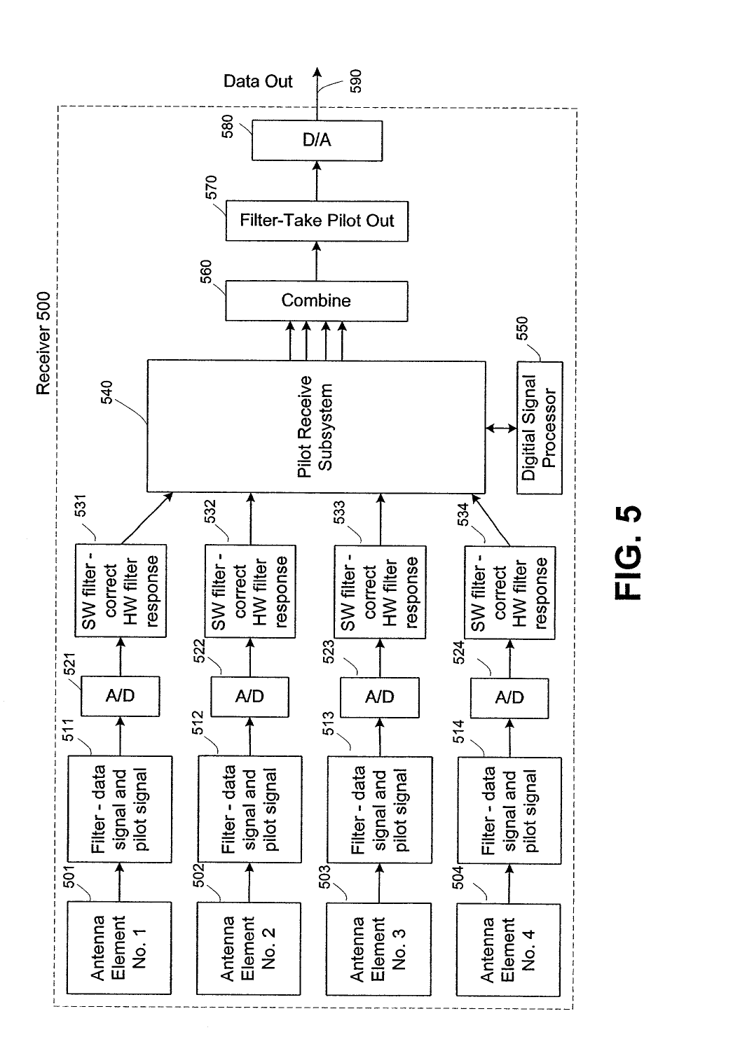

FIG. 5 shows a system block diagram of a receiver having a pilot receive subsystem, according to an embodiment of the invention. The embodiment shown in FIG. 5 can correspond to the receiver 131 of FIG. 1 and receiver 161 of FIG. 2. Note that although FIG. 5 shows a specific embodiment of a receiver having four antenna elements, a receiver can have any number of two or more antenna elements. Such a receiver will have component sets that correspond to the specific number of antenna elements for that receiver embodiment.

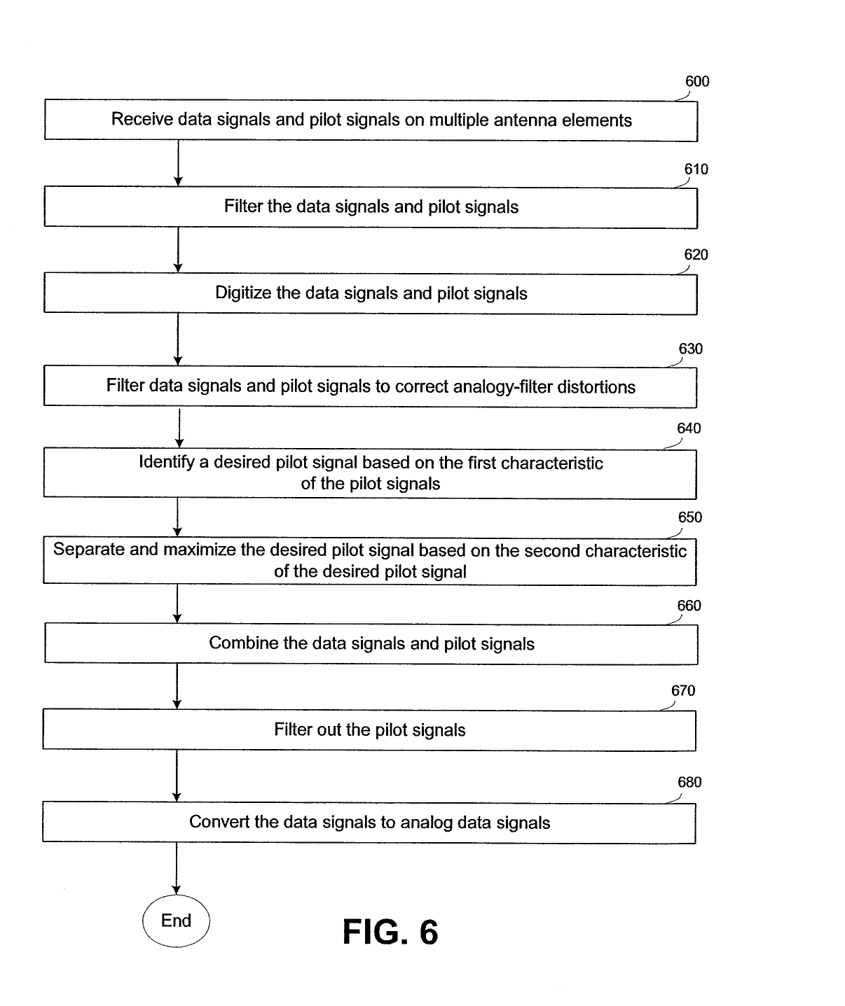

As shown in FIG. 5, receiver 500 includes antenna elements 501, 502, 503 and 504, which are coupled to filters 511, 512, 513 and 514, respectively. Filters 511, 512, 513 and 514 are coupled to A/D converters 521, 522, 523 and 524, respectively, which in turn are coupled to software filters 531, 532, 533 and 534, respectively. Software filters 531 through 534 are coupled to pilot receive subsystem 540, which is also coupled to digital signal processor 550 and combiner 560. Combiner 560 is coupled to filter 570, which in turn is coupled to D/A converter 580. For illustrative purposes, the operation of receiver 500 will be explained in reference to the flow chart of FIG. 6.

FIG. 6 shows a flowchart for receiving and enhancing data signals according to an embodiment of the present invention. At step 600, data signals and pilot signals are received on multiple antenna elements. The data signals and pilot signals can be received separately, for example, on antenna elements 501 through 504 as shown in FIG. 5. Thus, each antenna element will generate a composite of the data signals and pilot signals received at its given location.

At step 610, each filter (i.e., 511 to 514) filters the data signals and pilot signals received by its associated antenna elements. As shown in FIG. 5, these data signals and pilot signals can be filtered at filters 511 through 514. These filters can be, for example, hardware filters that filter the signals while in an analog form. At step 620, the filtered data signals and pilot signals are digitized. The data signals and pilot signals can be digitized, for example, by A/D converters 521 through 524. In other words, the signals from filters 511 through 514 are provided to A/D converters 521 through 524, respectively, which digitize each set of signals.

At 630, the digitized data signals and pilot signals are filtered in software to correct for distortions due to the hardware filters 511 through 514. In other words, software filters 531, 532, 533 and 534 correct for distortions that were induced by filters 511, 512, 513 and 514, respectively.

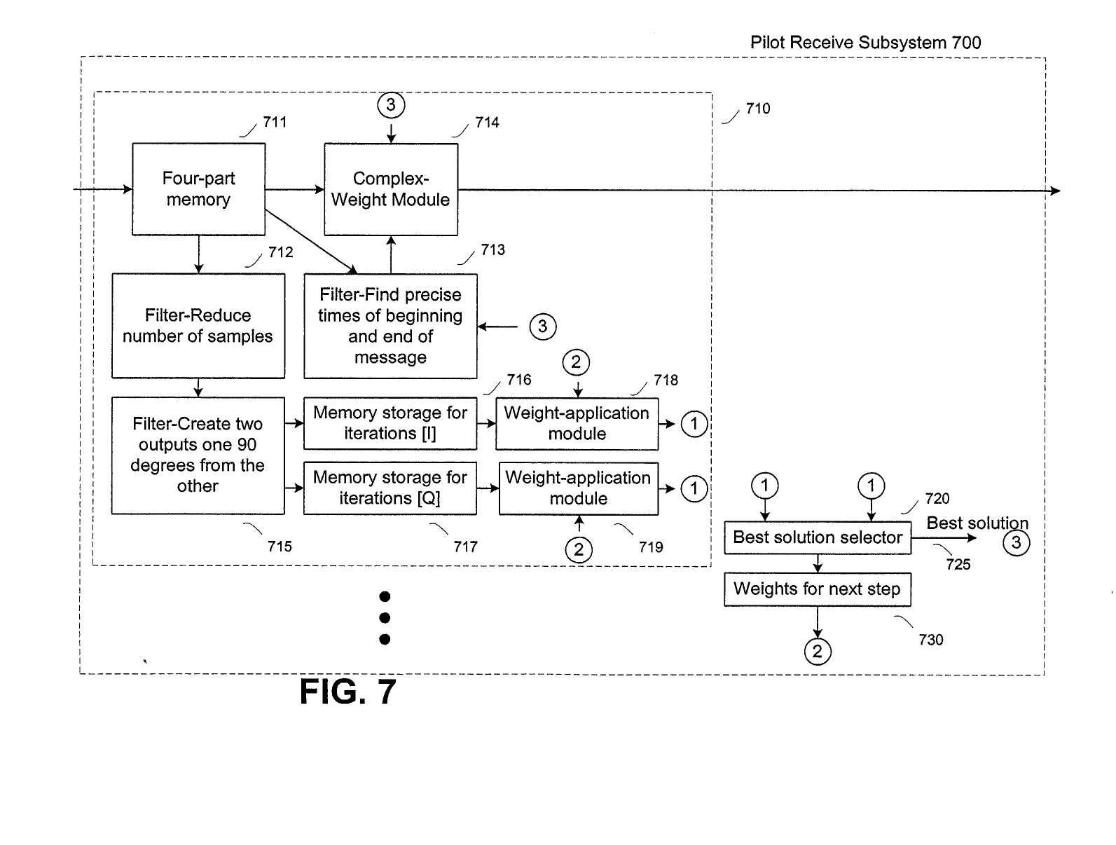

At step 640, the desired pilot signal is identified based on the first characteristic of the pilot signals. As shown in FIG. 5, digital signal processor 550 can identify the desired pilot signal from the pilot signals stored in pilot-receive subsystem 540 by, for example, a specific frequency or frequency band of the desired pilot signal. Note that digital signal processor 550 can also provide the appropriate control/status signals to the components of the pilot-receive subsystem 540 via connections not shown in FIG. 5. These components of pilot-receive subsystem 540 are described in further detail below in reference to FIG. 7.

At step 650, the desired pilot signal is separated and maximized based on the second characteristic of the desired pilot signal. For example, the second characteristic of the desired pilot signal can be the total power within the power-signal band for that desired pilot signal. Based on this second characteristic, the pilot-receive subsystem 540 can then adjust the weight values associated with antenna elements 501 through 504 so that the power across the pilot-signal band for the desired pilot signal is maximized. Consequently, the power across the pilot-signal bands for the remaining pilot signals (i.e., the undesired pilot signals) will be minimized by this process. Also, because enhancing the desired pilot signal corresponds to changes in the desired data signal, the desired data signal will also be maximized in the process of maximizing the desired pilot signal.

At step 660, the data signals and pilot signals output from the pilot-receive subsystem 540 are combined by combiner 560. More specifically, the pilot-receive subsystem 540 produces a set of outputs (each having data signals and pilot signals) where each output uniquely corresponds to an antenna element 501 through 504. Combiner 560 combines this set of outputs into a single output having the data signals and pilot signals corresponding to all of the antenna elements 501 through 504.

At step 670, the pilot signals are filtered out so that only the data signals remain. Turning to FIG. 5, the pilot signals can be filtered out by filter 570, which can be for example a band-pass filter. Following the example shown in FIG. 3, the band-pass filter 570 can correspond to the data frequency band 210 shown in FIG. 3. Correspondingly, the pilot signals within pilot signal bands 220 through 270 are removed by band-pass filter 570.

At step 680, the data signals (in digital form) are converted to analog signals 590. Note that the analog data signals 590 produced by D/A converter 580 represents the desired data signal as well as the undesired data signals. Due to the maximization process performed by pilot-receive subsystem 540, however, the desired data signals are maximized or enhanced while the remaining data signals (i.e., undesired data signals) are minimized. Consequently, these undesired data signals interfere with the desired data signal less and the desired data signal is enhanced.

FIG. 7 shows a system block diagram of a pilot-receive subsystem according to an embodiment of the invention. More specifically, the pilot-receive subsystem 700 shown in FIG. 7 corresponds to the pilot-receive subsystem 540 shown in FIG. 5.

Pilot-receive subsystem 700 includes circuits 710. Note that although only one circuit 710 is shown in FIG. 7, multiple circuits are present within pilot-receive subsystem 700. The specific number of circuits 710 corresponds to the specific number of antenna elements (e.g., antenna elements 501 through 504 shown in FIG. 5). Thus, for the receiver shown in FIG. 5 and having four antenna elements, pilot-receive subsystem 700 consequently has four circuits 710.

Circuit 710 includes four-port memory 711, which is coupled to filter 712, filter 713, and complex weight module 714. Filter 712 is coupled to filter 715, which is in turn coupled to memory storages 716 and 717. Memory storages 716 and 717 are coupled to weight-application modules 718 and 719, respectively.

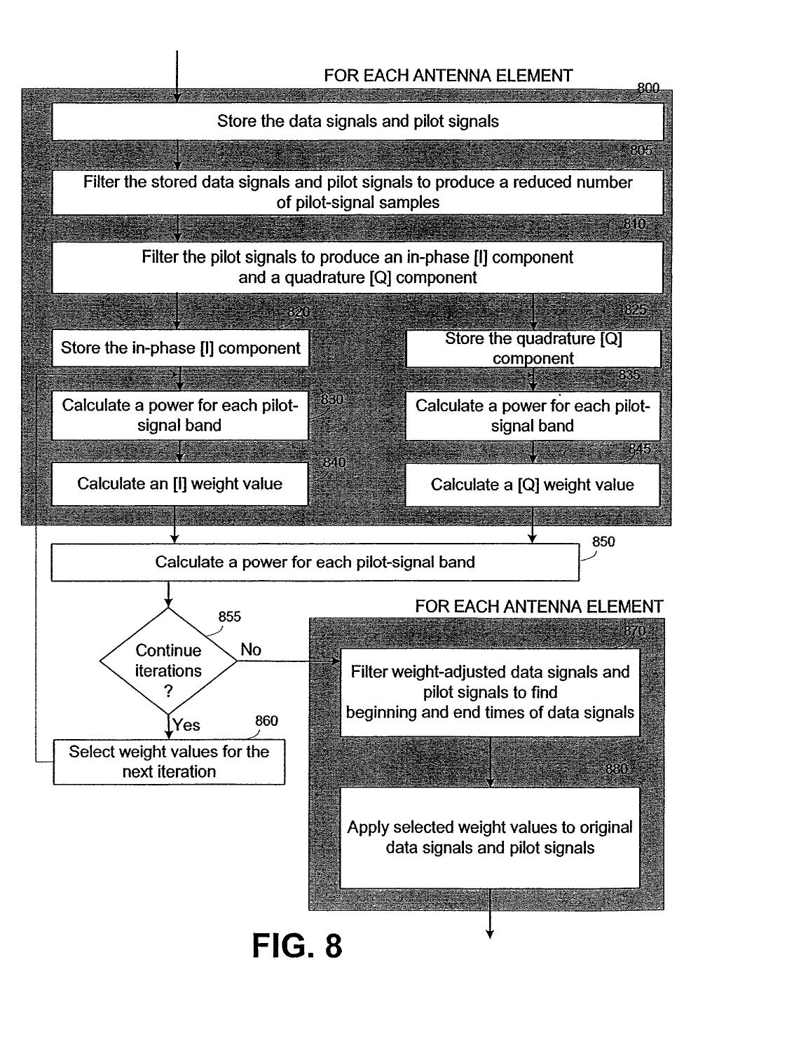

The weight-application modules 718 and 719 for each circuit 710 are coupled to best solution selector 720, which is in turn coupled to weight calculator 730. Weight calculator 730 is also coupled to weight-application modules 718 and 719 from each of the circuits 710. Best solution selector 720 also outputs a value 725 when a best solution for the weight values is obtained. This value 725 is also provided to the complex-weight module 714 of every circuit 710. The operation of pilot-receive subsystem 700 will now be described with reference to the flowchart shown in FIG. 8.

FIG. 8 shows a flowchart for separating and maximizing the desired pilot signal according to an embodiment of the present invention. More specifically, the flowchart shown in FIG. 8 corresponds to step 650 shown in FIG. 6 and typically is performed by pilot-receive subsystem 540 shown in FIG. 5.

Note that steps 800 through 845 shown in FIG. 8 are performed in parallel by separate circuits 710 each of which uniquely corresponds to an antenna element 501 through 504 shown in FIG. 5. More generally, the number of circuits will correspond to the number of antenna elements of a given receiver. Thus, although steps 800 through 845 are discussed in reference to a single circuit 710, the same steps are performed in parallel for all of the circuits 710.

At step 800, the data signals and pilot signals are stored. These data signals and pilot signals can be in digital form and received from one of the software filters 531 through 534 shown in FIG. 5. At step 805, the stored data signals and pilot signals are filtered to produce a reduced number of pilot-signal samples. In other words, the data signals within data frequency band 210 as shown in FIG. 3 are removed and only the pilot signals within pilot-signal bands 220 through 270 in FIG. 3 remain.

At step 810, these pilot signals are further filtered to produce an in-phase component and a quadature component. At step 820, the in-phase component is stored. At step 825, the quadrature component is stored. Turning to FIG. 7, the in-phase component produced by filter 715 is stored in memory storage 716, and the quadrature component produced by filter 715 is stored in memory storage 717. The stored pilot-signal samples stored in memory storage 716 and 717 can be used iteratively to determine the appropriate weight values associated with the in-phase and quadature signals.

The specific number of pilot-signal samples is related to the bandwidth of pilot-signal band. More specifically, the pilot-signal samples for a given pilot signal are collected over a time period on the order of 1/B, where B is the bandwidth of the pilot-signal band for that pilot signal. Consequently, the number of samples needed is relatively small. For example, for a pilot-signal band having a bandwidth of 20 kHz, the number of samples should be on the order of one per 25 μsec. Thus, for a message that is only 100 μsec long, only 4 samples are needed.

At step 830, the power for each pilot-signal band corresponding to the in-phase component is calculated. At step 835, the power for each pilot-signal band for the quadrature component is calculated.

At step 840, a weight value for the in-phase component is calculated. At step 845, a weight value for the quadrature component is calculated. Steps 830 and 840 can be performed by weight-application module 718. Steps 835 and 845 can be performed by weight-application module 719. The weight values can be calculated, for example, by applying a gradient descent to the power for each pilot-signal band calculated in steps 830 and 835.

At step 850, the power for each pilot-signal band is calculated for all antenna elements. More specifically, best solution selector 720 receives the weight values for the in-phase and quadature components from each circuit 710 and then determines the power for each pilot-signal band based on these new weight values. In other words, the best solution selector 720 receives two weight values (one for the in-phase component and the other for the quadrature component) for each circuit 710. Then, using these weight values (two weight values times the number of circuits 710), determines power for each pilot-signal band using these new weight values.

At conditional step 855, a determination is made as to whether to continue with another iteration of calculating weight values. For example, the iterations can continue until a maximum difference between the desired pilot-signal bands and the remaining pilot-signal bands has been achieved. Alternatively, the iterations can continue until a maximum number of iterations have been performed. Performing additional iterations allow the receiver possibly to obtain a new set of weight values that better enhance the desired pilot signal while suppressing the undesired pilot signals. If the iterations are to continue, then the process proceeds to step 860. At step 860, weight values for the next iteration are selected. Weight calculator 730 can perform step 860. These newly selected weight values are then provided to the weight-application modules 718 and 719 for every circuit 710.

Returning to FIG. 8, after weight values for the next iteration are selected at steps 860, the process continues at steps 830 and 835 where the power for each pilot-signal band is calculated based on these newly selected weight values. The process then continues for steps 830 and 835 through to 855 until a determination is made that the iterations should no longer continue. At this point, the process proceeds to step 870. Note that the iterations can be performed at a relatively slow rate of, for example, one iteration per sample (i.e., comparing one sample to another during an iteration). Thus, for a configuration using six pilot-signal bands (and having six circuits 710), for example, two pilot-signal samples for each pilot-signal band, totaling 12 pilot-signal samples, can be compared for a given iteration by each circuit 710.

Steps 870 and 880 are performed for each antenna element. In other words, steps 870 and 880 are performed in parallel by each circuit 710. At step 870, the weight-adjusted data signals and pilot signals (using the final weight values 725) are filtered to find the beginning and end times of the data signals. Returning to FIG. 7, the final weight values 725 are provided to filter 713. Filter 713 also receives the original data signals and filter signals. Filter 713 uses the weight-adjusted values of the data signals and pilot signals to determine the precise beginning and end of the message within the desired data signal. These beginning and end times are then provided to complex-weight module 714.

At step 880, the final weight values are applied to the original data signals and pilot signals to produce an enhanced desired data signal. Returning to FIG. 7, complex-weight module 714 receives from four-port memory 711 a copy of the original data signals and pilot signals and also receives the final weight values 725 from best solution selector 720. Using the beginning and end times provided by filter 713, complex-weight module 714 then applies the final weight values to the original data signals and pilot signals and produces output data 740. As discussed above, now that the receiver has been optimized to receive the desired pilot signal, the desired data signal is also now optimized.

Although the above discussion of FIGS. 2 through 8 is based on specific embodiments where the pilot signals are narrow band signals within the guard band, many other types of embodiments are possible. For example, where the number of pilot signals within the system exceeds the number of narrow bands available within the guard bands, the pilot signals can be modulated with a code. Thus, two or more pilot signals within a given pilot-signal band can be identified by the modulation code. In this embodiment, the first characteristic of the pilot signals is a combination of the frequency and the modulation code.

In another embodiment, pilot signals can be included within the data-frequency band for a code-division multiple access (CDMA) system (i.e., a spread spectrum system). In such an embodiment, the pilot signals each can use a spread-spectrum pseudo-noise sequence for identification. The power in the spread-spectrum signal band (i.e., the data-frequency band based on the desired spread-spectrum pseudo-noise sequence) can be used to optimize the desired pilot signal. Thus, for this embodiment, the first pilot-signal characteristic is a spread-spectrum pseudo-noise sequence and the second pilot-signal characteristic is power in the spread-spectrum signal band.

In another embodiment, the pilot signals can be created as an artificial multipath. More specifically, the pilot signals can be included within the data-frequency band and can be generated with a time delay unique for that communication source. The specific time delay can be used as a pilot-signal identifier. The power of the delayed signal can be used to optimize the desired pilot signal. Thus, for this embodiment, the first pilot-signal characteristic is the amount of time delay for the pilot signal and the second pilot-signal characteristic is power of the desired pilot signal.

In yet another embodiment, the pilot signals can be embedded within an orthogonal frequency division multiplexing (OFDM) system. In this embodiment, the unused OFDM carriers can be modulated as pilot signals. Thus, for this embodiment, the first pilot-signal characteristic is the frequency of the pilot signals (e.g., the OFDM center frequencies for the pilot-signal bands) and the second pilot-signal characteristic is power of the desired pilot signal.

In yet another embodiment, the pilot signals can be within the data-frequency band and amplitude modulated with a unique code. Thus, for this embodiment, the first pilot-signal characteristic is the amplitude-modulation code of the pilot signals and the second pilot-signal characteristic is power of the desired amplitude-modulated pilot signal.

In yet another embodiment, the pilot signals can be within the data-frequency band and frequency shifted with a unique code. Thus, for this embodiment, the first pilot-signal characteristic is the frequency-shifted code of the pilot signals and the second pilot-signal characteristic is power of the desired frequency-shifted pilot signal.

In yet another embodiment, the pilot signals can be within the data-frequency band and phase shifted with a unique code. Thus, for this embodiment, the first pilot-signal characteristic is the phase-shifted code of the pilot signals and the second pilot-signal characteristic is power of the desired phase-shifted pilot signal.

### Conclusion

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalents.

The previous description of the embodiments is provided to enable any person skilled in the art to make or use the invention. While the invention has been particularly shown and described with reference to embodiments thereof, it will be understood by those skilled in the art that various changes in form and details may be made therein without departing from the spirit and scope of the invention.

For example, although FIG. 3 above describes an embodiment for narrow-band pilot signals for particular system parameters. Other types of system parameters are possible. For example, an embodiment can be configured within a multiple-channel cable system using the Data Over Cable Service Interface Specifications (DOCSIS) standard. For such an embodiment, the downlink can use a modulation of 64 QAM. Thus, within an assigned band of 6 MHz, the data-frequency band can use 5.4 MHz. A pilot-signal band can be 100 KHz and placed 150 kHz from the side of the data-frequency band. The pilot signal can have the substantially same power as the data signals without degrading the quality of the data signals.

For another example, an embodiment can be configured within a multiple-channel wireless communication system using, for example, the WiFi (i.e., the IEEE 802.11A) standard. Under this standard, the data-frequency band is divided into 64 quality-width channels but only 52 of these channels are actually used for data signals. Consequently, about 15 percent of the data-frequency band is unused by the data signals. Accordingly, pilot signals can be located on these unused channels.

For another example, an embodiment can be configured within a communication system according to the Broadband Wireless Internet Forum (BWIF) standard. Under this standard, consider an example of 128 channels within the data-frequency band. For this example, only 106 channels are used for data signals while the remaining 22 channels are zero-tone channels. Consequently, about 17 percent of the data-frequency band is unused by the data signals and pilot signals can be located on these unused channels.

What is claimed is:

1. A method for using a pilot signal to enhance a data signal associated with the pilot signal, comprising:
receiving a plurality of data signals and a plurality of pilot signals on a plurality of antenna elements, each data signal from the plurality of data signals being uniquely associated with a pilot signal from the plurality of pilot signals, each pilot signal from the plurality of pilot signals having a first characteristic and a second characteristic;
identifying a first pilot signal from the plurality of pilot signals based on the first characteristic of the first pilot signal; and
adjusting a first weight value associated with each antenna element from the plurality of antenna elements so that the second characteristic of the first pilot signal is substantially optimized with respect to the second characteristic of the remaining pilot signals from the plurality of pilot signals.

2. The method of claim 1, further comprising:
modifying the data signal associated with the first pilot based on the first weight value and a second weight value associated with each antenna element from the plurality of antenna elements to produce a modified data signal;
modifying a transmission data signal based on the first weight value and the second weight value associated with each antenna element from the plurality of antenna elements; and
transmitting the modified transmission data signal.

3. The method of claim 1, further comprising:
performing the following for each antenna element from the plurality of antenna elements:
storing a plurality of signal samples for the first pilot signal; and
filtering the plurality of signal samples for the first pilot signal to produce a plurality of in-phase signal samples and a plurality of quadature signal samples, the first weight value being associated with the plurality of in-phase signal samples, a second weight value being associated with the plurality of quadature signal samples; and
iteratively adjusting the first weight value and the second weight value associated with each antenna element from the plurality of antenna elements so that the second characteristic of the first pilot signal is substantially optimized with respect to the second characteristic of the remaining pilot signals from the plurality of pilot signals.

4. The method of claim 3, further comprising:
scanning, for each antenna element from the plurality of antenna elements, the stored plurality of signal samples for the first pilot signal to produce an indication of a beginning and an end of the data signal associated with the first pilot signal; and
initially applying the first weight value to the data signal associated with the first pilot signal at the beginning indication.

5. The method of claim 1, wherein:
the plurality of data signals is associated with a data frequency band within an allocated frequency band;
the plurality of pilot signals each is uniquely associated with a pilot-signal band within the allocated frequency band and outside the data frequency band;
the first characteristic of each pilot signal from the plurality of pilot signals is at least one from the group of: (a) a frequency of an unmodulated carrier wave and (b) a modulation and a frequency of a modulated carrier wave; and
the second characteristic of each pilot signal from the plurality of pilot signals is a power associated with that pilot signal.

6. The method of claim 1, wherein:
the plurality of data signals is associated with a data frequency band;
the plurality of pilot signals is associated with the data frequency band;
the first characteristic of each pilot signal from the plurality of pilot signals is a spread spectrum pseudo noise sequence; and
the second characteristic of each pilot signal from the plurality of pilot signals is a power in spread spectrum associated with that pilot signal.

7. The method of claim 1, wherein:
the plurality of data signals is associated with a data frequency band;
the plurality of pilot signals is associated with the data frequency band, each pilot signal being associated with its own time delay from the associated data signal from the plurality of data signals;
the first characteristic of each pilot signal from the plurality of pilot signals is the associated time delay; and
the second characteristic of each pilot signal from the plurality of pilot signals is a power associated with that pilot signal.

8. The method of claim 1, wherein:
each data signal from the plurality of data signals is uniquely associated with a frequency from a plurality of frequencies;
each pilot signal from the plurality of pilot signals is uniquely associated with a modulation code, each pilot signal from the plurality of pilot signals is uniquely associated with the a remaining frequency from the plurality of frequencies;
the first characteristic of each pilot signal from the plurality of pilot signals is the modulated code; and
the second characteristic of each pilot signal from the plurality of pilot signals is a power associated with that pilot signal.

9. The method of claim 1, wherein:
each data signal from the plurality of data signals is amplitude modulated with a unique pilot signal having an associated amplitude-modulation code and a power;
the first characteristic of each pilot signal from the plurality of pilot signals is the amplitude-modulation code associated with that pilot signal; and
the second characteristic of each pilot signal from the plurality of pilot signals is a power associated with that pilot signal.

10. The method of claim 1, wherein:
each data signal from the plurality of data signals is frequency-shift modulated with a unique pilot signal having an associated frequency-shift code and a power;
the first characteristic of each pilot signal from the plurality of pilot signals is the frequency-shift code associated with that pilot signal; and
the second characteristic of each pilot signal from the plurality of pilot signals is a power associated with that pilot signal.

11. The method of claim 1, wherein:
each data signal from the plurality of data signals is phase-shift modulated with a unique pilot signal having an associated phase-shift code and a power;
the first characteristic of each pilot signal from the plurality of pilot signals is the phase-shift code associated with that pilot signal; and
the second characteristic of each pilot signal from the plurality of pilot signals is a power associated with that pilot signal.

12. An apparatus having a plurality of antenna elements configured to receive a plurality of data signals and a plurality of pilot signals, each data signal from the plurality of data signals being uniquely associated with a pilot signal from the plurality of pilot signals, each pilot signal from the plurality of pilot signals having a first characteristic and a second characteristic, comprising:
a plurality of circuits each coupled to an antenna element from the plurality of antenna elements, each circuit having:
a filter, the filter configured to receive the plurality of data signals and the plurality of pilot signals, the filter configured to produce a first signal component and a second component;
a first weight-application module coupled to the filter, the first weight-application module configured to receive the first signal component and to apply a first weight value to the first signal component; and
a second weight-application module coupled to the filter, the second weight-application module configured to receive the second signal component and to apply a second weight value to the second signal component;
a processor coupled to the plurality of circuits, the processor configured to determine a first pilot signal from the plurality of pilot signals based on the first characteristic of the first pilot signal; and
a best solution selector coupled to the first weight-application module and the second weight-application module of each circuit from the plurality of circuits, the best solution selector configured to select an iteration value for the first weight value and the second weight value based on the second characteristic of the pilot signal.

13. The apparatus of claim 12, wherein:
the first weight-application module further configured to calculate the first weight value based on the first signal component so that the second characteristic of the first pilot signal is substantially optimized with respect to the second characteristic of the remaining pilot signals from the plurality of pilot signals;
the second weight-application module further configured to calculate the second weight value based on the second signal component so that the second characteristic of the first pilot signal is substantially optimized with respect to the second characteristic of the remaining pilot signals from the plurality of pilot signals.

14. The apparatus of claim 12, where each circuit from the plurality of circuits further includes:
a second filter coupled to the best solution selector, the filter configured to receive a final value for the first weight value and a final value the second weight value from the best solution selector, the second filter configured to identify a start indicator and an end indicator of the data signal from the plurality of data signals associated with the first pilot signal; and
a complex-weight module coupled to the second filter, the complex-weight module configured to receive the start indicator, the end indicator, the final value of the first weight value and the final value of the second weight value.

15. The apparatus of claim 12, wherein:
the plurality of data signals is associated with a data frequency band within an allocated frequency band;
the plurality of pilot signals each is uniquely associated with a pilot-signal band within the allocated frequency band and outside the data frequency band;
the first characteristic of each pilot signal from the plurality of pilot signals is at least one from the group of: (a) a frequency of an unmodulated carrier wave and (b) a modulation and a frequency of a modulated carrier wave; and
the second characteristic of each pilot signal from the plurality of pilot signals is a power associated with that pilot signal.

16. The apparatus of claim 12, wherein:
the plurality of data signals is associated with a data frequency band;
the plurality of pilot signals is associated with the data frequency band;
the first characteristic of each pilot signal from the plurality of pilot signals is a spread spectrum pseudo noise sequence; and
the second characteristic of each pilot signal from the plurality of pilot signals is a power in spread spectrum associated with that pilot signal.

17. The apparatus of claim 12, wherein:
the plurality of data signals is associated with a data frequency band;
the plurality of pilot signals is associated with the data frequency band, each pilot signal being associated with its own time delay from the associated data signal from the plurality of data signals;
the first characteristic of each pilot signal from the plurality of pilot signals is the associated time delay; and
the second characteristic of each pilot signal from the plurality of pilot signals is a power associated with that pilot signal.

18. The apparatus of claim 12, wherein:
each data signal from the plurality of data signals is uniquely associated with a frequency from a plurality of frequencies;
each pilot signal from the plurality of pilot signals is uniquely associated with a modulation code, each pilot signal from the plurality of pilot signals is uniquely associated with the a remaining frequency from the plurality of frequencies;
the first characteristic of each pilot signal from the plurality of pilot signals is the modulated code; and
the second characteristic of each pilot signal from the plurality of pilot signals is a power associated with that pilot signal.

19. The apparatus of claim 12, wherein:
each data signal from the plurality of data signals is amplitude modulated with a unique pilot signal having an associated amplitude-modulation code and a power;
the first characteristic of each pilot signal from the plurality of pilot signals is the amplitude-modulation code associated with that pilot signal; and
the second characteristic of each pilot signal from the plurality of pilot signals is a power associated with that pilot signal.

20. The apparatus of claim 12, wherein:
each data signal from the plurality of data signals is frequency-shift modulated with a unique pilot signal having an associated frequency-shift code and a power;
the first characteristic of each pilot signal from the plurality of pilot signals is the frequency-shift code associated with that pilot signal; and
the second characteristic of each pilot signal from the plurality of pilot signals is a power associated with that pilot signal.

21. The apparatus of claim 12, wherein:
each data signal from the plurality of data signals is phase-shift modulated with a unique pilot signal having an associated phase-shift code and a power;
the first characteristic of each pilot signal from the plurality of pilot signals is the phase-shift code associated with that pilot signal; and
the second characteristic of each pilot signal from the plurality of pilot signals is a power associated with that pilot signal.

22. A method for using a pilot signal in a communication receiver having a plurality of antenna elements, comprising:
receiving a plurality of data signals and a plurality of pilot signals;
identifying a first pilot signal from the plurality of pilot signals based on a first characteristic of the first pilot signal from the plurality of pilot signals; and
adjusting a plurality of weight values associated with the plurality of antenna elements so that a second characteristic of the first pilot signal is substantially optimized with respect to the second characteristic of the remaining pilot signals from the plurality of pilot signals,
whereby a first data signal from the plurality of data signals and being uniquely associated with the first pilot signal is substantially optimized by the adjusting of the plurality of values associated with the plurality of antenna elements.
